(19) United States
(12) Patent Application Publication
(10) Pub. No.: US 2003/0123809 A1
(43) Pub. Date: Jul. 3, 2003

(54) Optic-fiber connector positioning mechanism

(76) Inventor: Kuo-Tsai Huang, Sanchung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/251,956

(22) Filed: Sep. 23, 2002

(30) Foreign Application Priority Data
Dec. 28, 2001 (TW) 90223485

(51) Int. Cl. G02B 6/36

(52) U.S. Cl. 385/53; 385/76

(57) ABSTRACT

A positioning mechanism of this invention includes a casing having a chamber therein, wherein the casing has a resilient buckling piece, which can be moved up and down, located at bottom of the casing, and the resilient buckling piece has an opening thereon; an insulated main body with a flexible slice and a buckling protrusion formed at the insulated main body's bottom, wherein a through hole is formed at the top of the insulated main body right above the flexible slice, and the insulated main body can be inserted into the chamber of the casing and the buckling protrusion buckles the opening; and a depressing member combined with the through hole, wherein a lower end of the depressing member is in contact with the flexible slice, and when one depresses the depressing member, the buckling protrusion disengages with the opening.

### BACKGROUND OF THE INVENTION

1. Field of the Invention

The present invention relates to an improved optic-fiber connector positioning mechanism and in particular, an user-friendly positioning mechanism that can save time of disassembling an insulated main body and the casing.

2. Description of the Prior Art

FIG. 1 and FIG. 2 illustrate a typical optic fiber connector assembly comprising a casing 10a and an insulated main body 20a. The casing 10a, which is made of metals, is a hollow casing with an opening located at its front end. The casing 10a is typically soldered and fixed onto a circuit board 30a. Conventionally, the insulated main body 20a is made of plastic materials. At the front end of the insulated main body 20a there are provided two slots 21a for receiving other connectors. The insulated main body 20a can be inserted into the casing 10a and the casing 10a plays a role of protecting the insulated main body 20a. To firmly fix the insulated main body 20a within the hollow casing 10a, in general, a buckling protrusion 22a is formed at the bottom surface of the insulated main body 20a, and at the bottom of the casing 10a an associated resilient buckling piece 11a is provided. The resilient buckling piece 11a has a free distal end that slightly inclines forward such that the free distal end can be slightly moved up and down. Further, an opening 12a associated with the buckling protrusion 22a is formed on the resilient buckling piece 11a.

When one inserts the insulated main body 20a into the casing 10a, the buckling protrusion 22a buckles the opening 12a of the resilient buckling piece 11a, thereby positioning and restraining the insulated main body 20a. However, the above-mentioned prior art optic fiber connector assembly has a shortcoming that when one needs to disassemble the insulated main body 20a from the casing 10a, he or she usually has to use a slender stick,such as a screwdriver to disengage the resilient buckling piece 1la with the buckling protrusion 22a, and at the same time, draw out the insulated main body 20a from the casing 10a. The process is not user-friendly and inefficient since users have to find other tools such as a screwdriver.

Accordingly, there is a strong need for an improved optic fiber connector structure which is user-friendly and can be disassembled efficiently without the need of using extra tools.

### SUMMARY OF THE INVENTION

The main objective of the invention is to provide an improved optic-fiber connector positioning mechanism to solve the above-mentioned problems. In accordance with the present invention, an optic-fiber connector positioning mechanism is provided. The positioning mechanism of this invention comprises a casing having a chamber therein, wherein the casing has a resilient buckling piece, which can be moved up and down, located at bottom of the casing, and the resilient buckling piece has an opening thereon; an insulated main body with a flexible slice and a protrusion formed at the main body's bottom, wherein a through hole is formed at the top of the main body right above the flexible slice, and the main body can be inserted into the chamber of the casing and the protrusion buckles the opening; and a depressing member combined with the through hole, wherein a lower end of the depressing member is in contact with the flexible slice, and when one depresses the depressing member, the protrusion disengages with the opening.

Other objects, advantages and novel features of the invention will become more clearly and readily apparent from the following detailed description when taken in conjunction with the accompanying drawings.

### BRIEF DESCRIPTION OF THE DRAWINGS

FIG. 1 illustrates a perspective view of optic-fiber connector components according to the prior art.

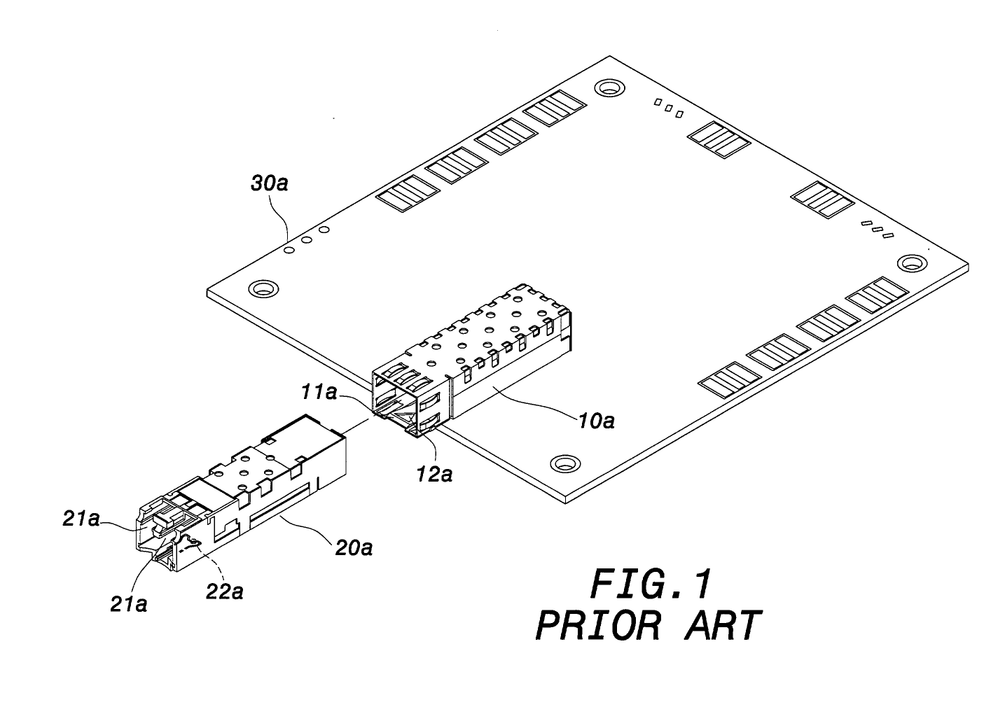

FIG. 2 illustrates a cross-sectional view of optic-fiber connector components according to the prior art.

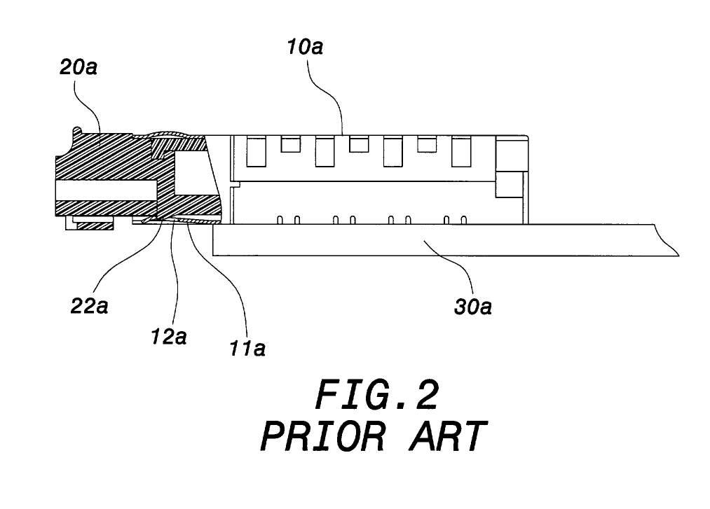

FIG. 3 is an exploded diagram showing this invention.

FIG. 4 is a plan view of the main body of this invention, from a bottom aspect.

FIG. 5 is a perspective view of this invention.

FIG. 6 is a cross-sectional view of this invention.

FIG. 7 and FIG. 8 illustrate the operation of this invention.

FIG. 9 is a schematic diagram showing an optic-fiber connector and this invention.

### DETAILED DESCRIPTION OF THE PREFERRED EMBODIMENT

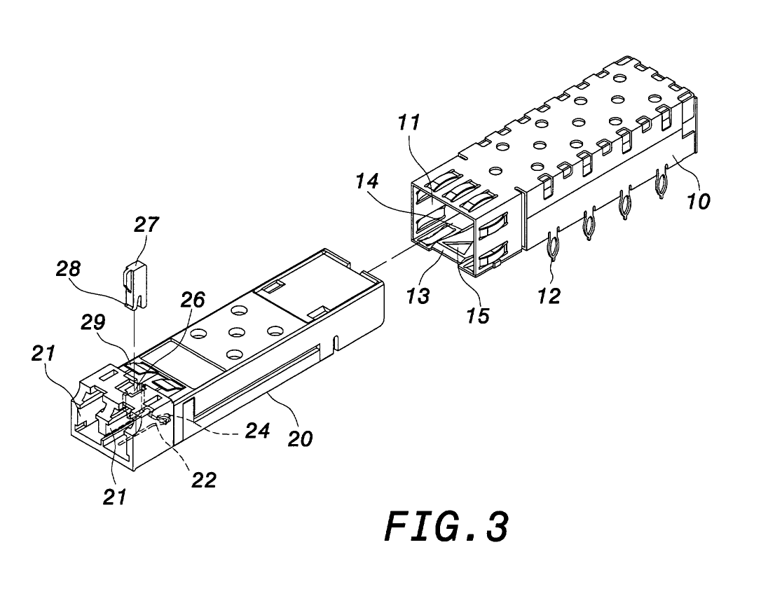

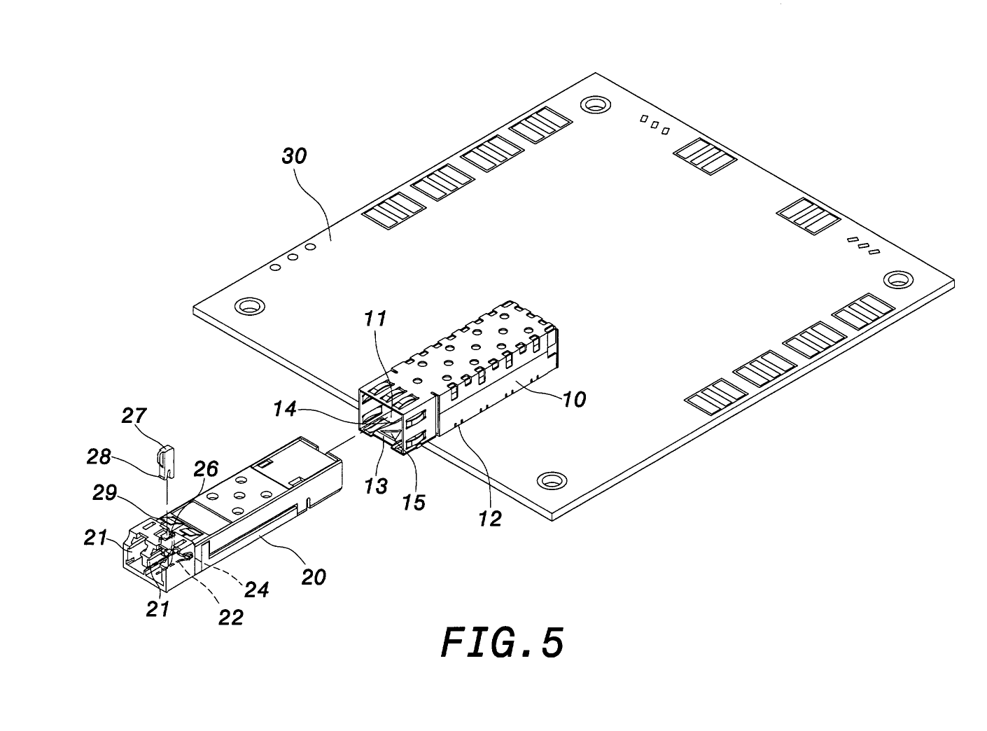

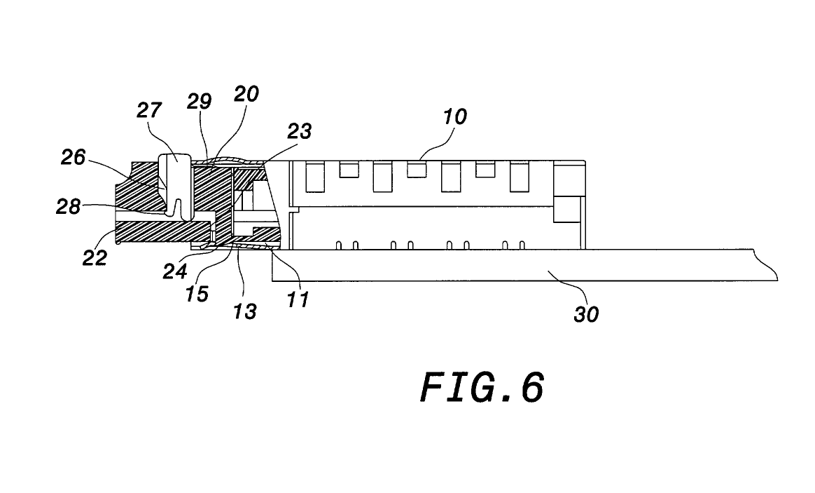

Please refer to FIG. 3. The present invention is directed to an improved optic-fiber connector positioning structure. As shown in FIG. 3, the positioning structure of this invention comprises a casing 10 and an insulated main body 20. The casing 10, which is made of metals and has chamber 11 therein, is generally a hollow casing with an opening located at its front end. The casing 10 with a plurality of contact pins 12 thereunder is typically soldered and fixed onto a circuit board 30, as shown in FIG. 5 and FIG. 6. At the inner bottom of the casing 10 near the opening there is provided a resilient buckling piece 13. Along two opposite sides of the resilient buckling piece 13 are two separating grooves 14. The resilient buckling piece 13 has a free distal end that slightly inclines forward such that the free distal end can be slightly moved up and down. Further, an opening 15 is formed on the resilient buckling piece 13. The casing 10 has a structure similar to the aforementioned prior art, and is thus not discussed further.

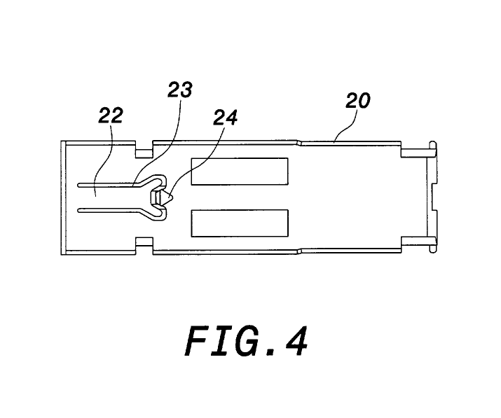

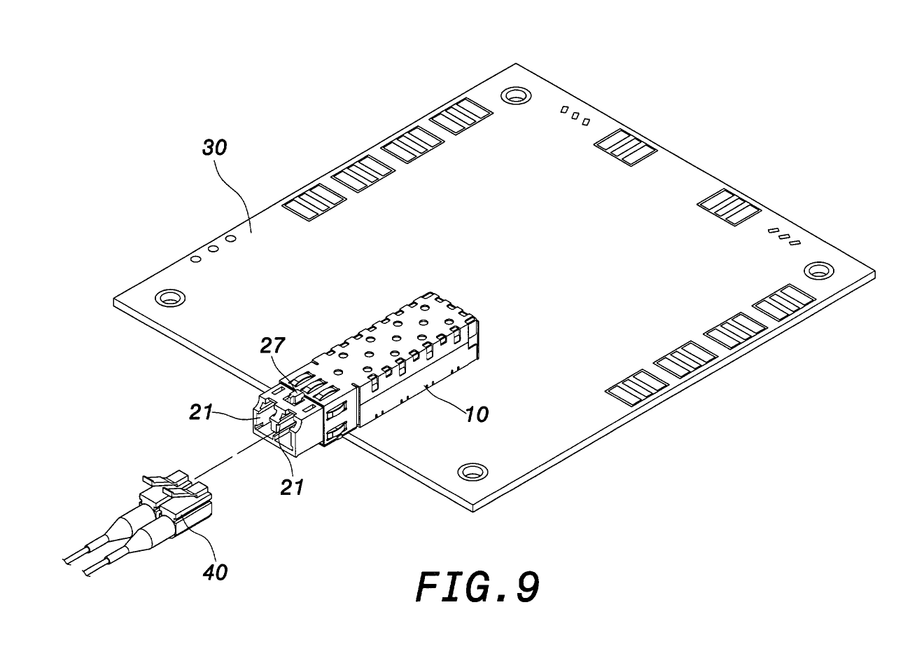

The insulated main body 20 is made of plastic materials. At the front end of the insulated main body 20 there are provided two slots 21 for receiving other connectors 40 (shown in FIG. 9). Referring to FIG. 4, a flexible slice 22 is formed at the bottom of the insulated main body 20. The flexible slice 22 is integrally formed with the main body 20 and is shaped by an approximately U-shaped separating groove 23, thereby forming a free distal back end of the flexible slice 22. The free distal back end can be slightly moved up and down with an outer force. A buckling protrusion 24 is provided at the bottom of the insulated main body 20 in proximity to the free distal back end of the flexible slice 22. At the top surface of the insulated main body 20 there is provided a through hole 26, which is right above the flexible slice 22. When assembling, the through hole 26 is combined with a depressing member 27. The depressing member 27, which has a reverse hook 28 at its lower end, is inserted into the through hole 26. When the depressing member 27 is inserted into the through hole 26, the reverse hook 28 engages with lower peripheral edge of the through hole 26, thereby preventing the depressing member 27 from sliding out of the through hole 26. The most lower end of the depressing member 27 is in contact with the flexible slice 22, which provides an upward resilient force for the depressing member 27, thereby protruding an upper portion of the depressing member 27 from the through hole 26. In addition, two metal resilient pieces 29 are provided at the top surface of the insulated main body 20.

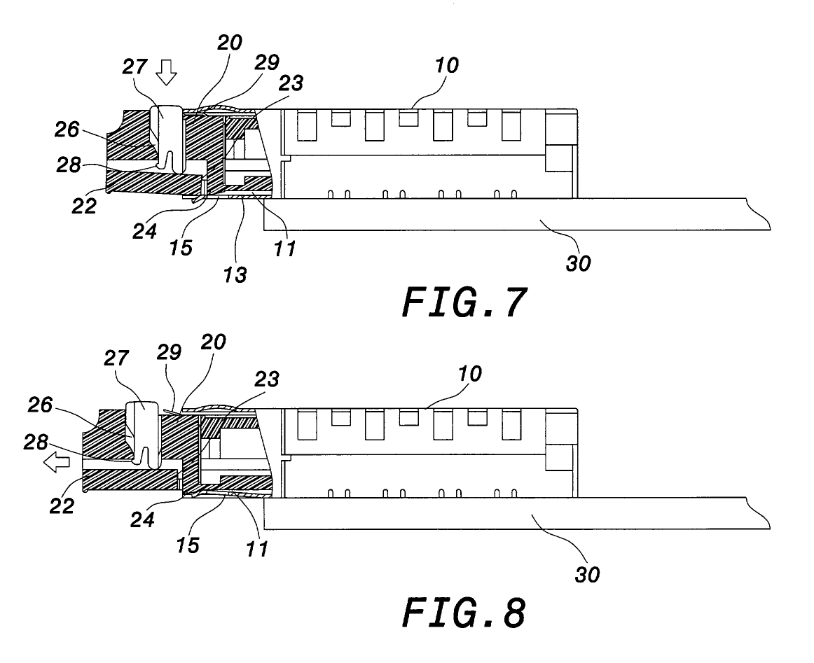

The insulated main body 20 can be inserted into the casing 10 and the casing 10 plays a role of protecting the insulated covered main body 20. A front portion of the insulated main body 20 protrudes from the casing 10. When assembling, the insulated main body 20 is inserted into the casing 10 to a positioning depth where the buckling protrusion 24 buckles the opening 15, as shown in FIG. 6, whereby ensuring the firmly connection between the insulated main body 20 and the casing 10. One end of each of the metal resilient pieces 29 is in contact with the casing 10, and the other end of each of the metal resilient pieces 29 is connected with the optic-fiber connector thereof to form a grounded circuiting. Referring to FIG. 7, when one needs to disassemble the insulated main body 20 from the casing 10, he or she only depresses the depressing member 27. The depressing member 27 is pushed downwardly and the most-lower end of the depressing member 27 at the same time pushes the flexible slice 22, and the flexible slice 22 then pushes the subjacent resilient buckling piece 13 to move downward, thereby disengaging the opening 15 with the buckling protrusion 24 at the bottom of the insulated main body 20. Not releasing the depressing member 27, the user then can easily draw out the main body 20 from the casing 10, as shown in FIG. 8.

To sum up, the present invention provides an improved disassembly mechanism related to an optic-fiber connector assembly. The present invention features that the user can operates the disassembly of the optic-fiber connector assembly simply by depressing the depressing member 27 located at a top surface of the connector assembly. No extra tools are needed during doing the disassembly.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

### What is claimed is:

1. An optic-fiber connector positioning mechanism, comprising:
a casing having a chamber therein, wherein the casing has a resilient buckling piece, which is moved up and down, located at bottom of the casing, and the resilient buckling piece has an opening thereon;
an insulated main body with a flexible slice and a buckling protrusion formed at the main body's bottom, wherein a through hole is formed at the top of the insulated main body right above the flexible slice, and the insulated main body can be inserted into the chamber of the casing and the buckling protrusion buckles the opening; and
a depressing member combined with the through hole, wherein a lower end of the depressing member is in contact with the flexible slice, and when one depresses the depressing member, the buckling protrusion disengages with the opening.

2. The optic-fiber connector positioning mechanism as claimed in claim 1 wherein the resilient buckling piece is formed at the bottom of the casing and near the front end of the casing.

3. The optic-fiber connector positioning mechanism as claimed in claim 1 wherein the flexible slice is defined by a separating groove.

4. The optic-fiber connector positioning mechanism as claimed in claim 1 wherein a reverse hook is provided at the bottom of the depressing member, and the reverse hook engages with lower peripheral edge of the through hole.

5. The optic-fiber connector positioning mechanism as claimed in claim 1 wherein grounding resilient pieces are provided at the top of the insulated main body and in contact with the casing.
